(19) United States
(12) Patent Application Publication
(10) Pub. No.: US 2004/0222556 A1
(43) Pub. Date: Nov. 11, 2004

(54) Method for producing bonded non-wovens from at least partially microfine continuous fibres and non-wovens thereby produced

(76) Inventors: Luder Gerking, Berlin (DE); Gerold Fleissner, Zug (CH)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/479,851

(22) PCT Filed: Jun. 4, 2002
(86) PCT No.: PCT/EP02/06075

(30) Foreign Application Priority Data
Jun. 7, 2001 (DE) 101-27-471.8

(51) Int. Cl. B29C 31/00; B27N 3/10

(52) U.S. Cl. 264/257

(57) ABSTRACT

Non-wovens from water-entangled continuous split fibres and such fibres produced by the meltblown method are known per se. Split fibres are composed of several polymers and are expensive to produce. The drawing air which must be heated to high temperatures in the meltblown method impairs the resistance of the fibres, which are often tom forming staple fibres. The non-wovens or parts of the non-wovens are preferably made from continuous fibres, which burst in a longitudinal direction during production due to high hydrostatic pressure inside the fibre, forming monofilaments with a diameter of approximately 2 μm, whereby fine, resistant continuous filaments are produced. Non-wovens produced using said thin fibres are bonded using hydrodynamic needling in order to obtain abrasion-resistant wipe non-wovens.

DE-A-199 29 709 teaches a fiber production method in which, from a polymer melt of only one certain polymer, filaments are spun from a plurality of spinning apertures and the spun filaments are drawn by substantially cold gas streams accelerated to high velocity by an accelerating nozzle such as a Laval nozzle and, due to further production conditions, each fiber receives before solidification an internal hydrostatic pressure that is higher than the ambient gas pressure so that each fiber cracks in the longitudinal direction and splits up into a plurality of fine endless filaments. These endless microfibers can then be progressively laid to form a nonwoven of arbitrary width.

This fiber production method has significant advantages over the prior art involving the melt-blowing method, with which microfibers are also produced. The filaments are very fine, having an average diameter of roughly 2 μm and being essentially endless even at this diameter. Because they are not stretched by a hot air stream as in the melt-blowing method, they undergo no thermal damage and have high strength. The filaments can be produced from any polymer but also from solutions according to the Lyocell method.

So-called split fibers are also microfibers. They arise from filaments spun from a plurality of polymers and subsequently split, for example by water jets. This microfiber production method is, however, more expensive.

The necessity exists of strengthening the microfibers produced as defined at the outset.

The idea of the invention is to effect this by hydrodynamic needling. This is especially effective here because these very thin endless fibers so produced can easily be displaced by water-needling and, despite their endlessness, entangled with nearby fibers. The result is an abrasion-resistant product; this is still the case when the nonwoven fabric has become wet. The product is not only abrasion-resistant but also displays no pilling effect, because entangled endless fibers are involved and these, in the case of normal endless fibers, have a longitudinal strength that makes them difficult to displace with water.

The application of hydrodynamic needling in this field is already known in several cases. With regard to melt-blown fibers, reference is made to EP-A-0 333 228; with regard to split fibers, to U.S. Pat. No. 4,233,349. In the present case, the application of water needling is especially advantageous because the product can be tightly needled with water jets in spite of the endless fibers so that no pilling effect occurs in the subsequent use of the strengthened nonwoven. The nonwoven fabric has a soft and quite uniform surface, and can therefore be used with great advantage for many applications in industry.

DE-A-199 29 709 teaches a fiber production method in which, from a polymer melt of only one certain polymer, filaments are spun from a plurality of spinning apertures and the spun filaments are drawn by substantially cold gas streams accelerated to high velocity by an accelerating nozzle such as a Laval nozzle and, due to further production conditions, each fiber receives before solidification an internal hydrostatic pressure that is higher than the ambient gas pressure so that each fiber cracks in the longitudinal direction and splits up into a plurality of fine endless filaments. These endless microfibers can then be progressively laid to form a nonwoven of arbitrary width.

This fiber production method has significant advantages over the prior art involving the melt-blowing method, with which microfibers are also produced. The filaments are very fine, having an average diameter of roughly 2 or 3 μm and being essentially endless even at this diameter. Because they are not stretched by a hot air stream as in the melt-blowing method, they undergo no thermal damage and have high strength. The filaments can be produced from any melt-spinnable polymer.

So-called split fibers are also microfibers. They arise from filaments spun from a plurality of polymers and subsequently, after laying, split into a felt, for example by water jets. This method is described in U.S. Pat. No. 5,970,583 or DE-A 199 34 442. This microfiber production method is more expensive and leads to a different product because the spun filaments consist of different polymers and the split filaments cannot be made into a felt until they have been laid.

The necessity exists of strengthening the microfibers produced as defined at the outset.

The idea of the invention is to effect this by hydrodynamic needling. This is especially effective here because these very thin endless fibers so produced, laid after manufacture, can easily be displaced by water-needling and, despite their endlessness, entangled with nearby fibers. The result is an abrasion-resistant product; this is still the case when the nonwoven fabric has become wet. The product is not only abrasion-resistant but also displays no pilling effect, because entangled endless fibers are involved and these, in the case of normal endless fibers, have a longitudinal strength that makes them difficult to displace with water.

The application of hydrodynamic needling in this field is already known in several cases. With regard to melt-blown fibers, reference is made to EP-A-0 333 228; with regard to split fibers, to U.S. Pat. No. 4,233,349. In the present case, the application of water needling is especially advantageous because the product already made from the fine filaments can be tightly needled with water jets in spite of the endless fibers so that no pilling effect occurs in the subsequent use of the strengthened nonwoven. The nonwoven fabric has a soft and quite uniform surface, and can therefore be used with great advantage for many applications in industry.

1. Method for producing a strengthened nonwoven from at least partly microfine endless fibers made of fusible polymers,
a) in which a polymer melt of only one certain polymer is spun from a plurality of spinning apertures and the spun filaments are drawn by substantially cold gas streams accelerated to high velocity by an accelerating nozzle such as a Laval nozzle and, due to further production conditions, each fiber receives before solidification an internal hydrostatic pressure that is higher than the ambient gas pressure so that each fiber cracks in the longitudinal direction and splits up into a plurality of fine endless filaments;
b) continuous laying of these microfibers to form a nonwoven of arbitrary width,
c) continuous subjection of this nonwoven fabric to hydrodynamic water jets in order to tangle the microfibers with one another so as to strengthen the nonwoven made of the lengthwise split endless fibers
d) and blending and bonding with other fibers previously laid under the microfibers and/or subsequently laid onto the microfibers, as appropriate.

2. Method according to claim 1 wherein the other fibers are made of natural or other synthetic fibers such as staple fibers or endless fibers.

3. Method according to claim 1 wherein the other fibers are made of wood pulp fibers, together with the other synthetic fibers as appropriate.

4. Strengthened nonwoven consisting at least in part of microfibers
a) that are spun from a polymer melt of only one certain polymer from a plurality of spinning apertures and the spun filaments are drawn by gas streams accelerated to high velocity by an accelerating nozzle such as a Laval nozzle and, due to further production conditions, each fiber receives before solidification an internal hydrostatic pressure that is higher than the ambient gas pressure so that each fiber cracks in the longitudinal direction and splits up into a plurality of fine endless filaments
b) and are strengthened by hydrodynamic needling, alone or together with other fibers such as also staple fibers and/or endless fibers.

5. Nonwoven according to claim 4 wherein the microfibers are laid onto a support ply made of more-stable chemical fibers and serve as a parting ply for a wood pulp ply laid onto the microfibers.
